(19) United States
(12) Patent Application Publication
(10) Pub. No.: US 2014/0326232 A1
(43) Pub. Date: Nov. 6, 2014

(54) DUAL-FUEL GAS-PELLET BURNER ASSEMBLY

(71) Applicant: Joe Traeger, Mt. Angel, OR (US)

(72) Inventor: Joe Traeger, Mt. Angel, OR (US)

(21) Appl. No.: 14/120,191

(22) Filed: May 2, 2014

Related U.S. Application Data
(60) Provisional application No. 61/818,841, filed on May 2, 2013.

(51) Int. Cl. A47J 37/07

(52) U.S. Cl. CPC A47J 37/0713; A47J 37/0786
USPC 126/25 R

(57) ABSTRACT

A dual-fuel gas-pellet barbecue burner assembly includes a combustion chamber, a pellet burner sub-assembly, and a gas burner sub-assembly. The pellet burner sub-assembly includes a motor-driven auger to deliver fuel pellets to the combustion chamber, and the gas burner sub-assembly includes a gas line that extends into the combustion chamber so that either pellets, gas, or both can be burned in the combustion chamber.

### RELATED APPLICATION

This application claims the benefit of U.S. provisional application No. 61/818,841, filed May 2, 2013.

### TECHNICAL FIELD

The present invention relates generally to wood pellet-burning barbecues, and, more particularly, to a dual-fuel gas-pellet burner for use with such barbecues.

### BACKGROUND OF THE INVENTION

Wood pellet-burning barbecues are popular for outdoor cooking, particularly at homes and in household situations. Conventional wood pellet-burning barbecues, of the type described in U.S. Pat. No. 4,823,684, employ a motor-driven auger to provide a measured feed of wood pellets into a combustion region where the pellets are burned to provide heat and smoke to cook food.

An aspect of such conventional wood pellet-burning barbecues is that the heat generated for larger cooking areas can be limited. While some household barbecues can be large enough to pose such a problem, the issue can become significant in the context of the requirements of commercial cooking. Commercial cooking can require very large cooking areas to serve a larger clientele, and can also require higher cooking heat to achieve desired cooking results. As a result, there is a need to provide improved heat generation in some pellet burning barbecues.

### SUMMARY OF THE INVENTION

Therefore, an aspect of the present invention is to provide a pellet-burning barbecue burner assembly that generates sufficient heat to accommodate larger barbecues, such as those suitable for commercial (e.g., restaurant or catering) uses. Accordingly, the present invention includes a dual-fuel gas-pellet barbecue burner assembly that includes a combustion chamber, a pellet burner sub-assembly, and a gas burner sub-assembly. The pellet burner sub-assembly includes a motor-driven auger to deliver fuel pellets to the combustion chamber, and the gas burner sub-assembly includes a gas line that extends into the combustion chamber so that either pellets, gas, or both can be burned in the combustion chamber.

### BRIEF DESCRIPTION OF THE DRAWINGS

FIG. 1 is a side elevation, with portions broken away, of a prior art wood pellet-burning barbecue.

FIG. 2 is a side view of one implementation of a dual-fuel gas-pellet burner according to the present invention.

FIG. 3 is a plan view, with portions broken away, of the dual-fuel gas-pellet burner of FIG. 2.

FIG. 4 is schematic plan view another implementation of a dual-fuel gas-pellet burner according to the present invention.

FIG. 5 is an isometric elevation illustration of a combustion chamber that may be used in the dual-fuel gas-pellet burner of FIG. 4.

FIG. 6 is an illustration of a controller that includes pellet burner control and a separate gas burner control for a dual-fuel gas-pellet burner.

### DETAILED DESCRIPTION OF THE INVENTION

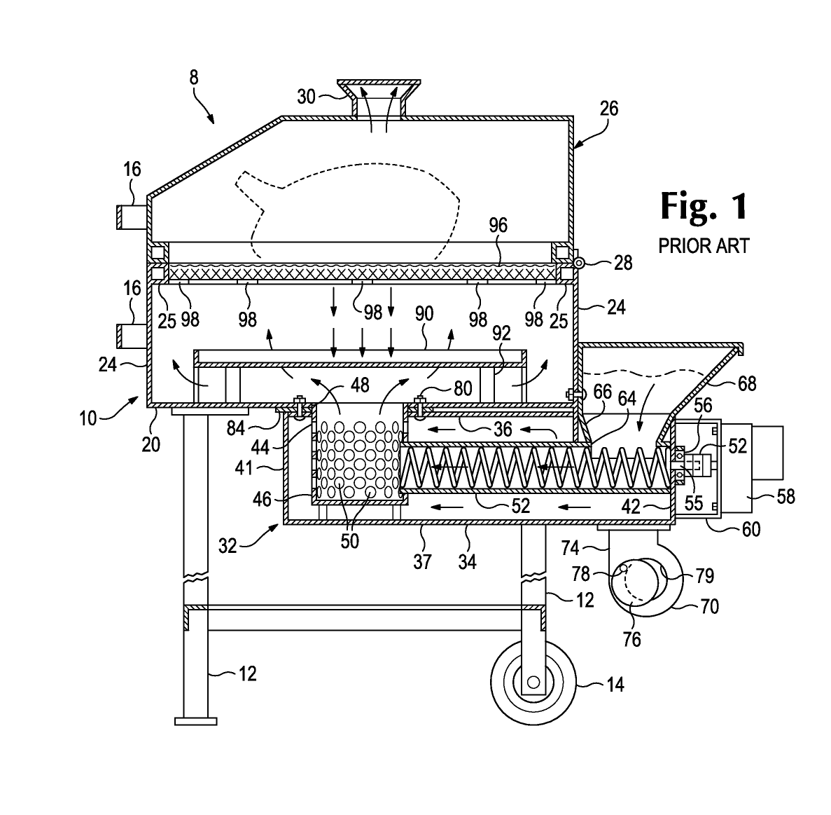

FIG. 1 is a side elevation, with portions broken away, of a prior art pellet-burning barbecue 8 described in U.S. Pat. No. 4,823,684. Barbecue 8 is configured to place the top of a pan 10 at a convenient working height above the ground, through legs 12 secured to and extending downwardly from the base of the pan 10. For convenience of moving, if desired, wheels 14 are provided rotatably journaled on the base of two of the legs in the barbecue. For moving purposes, the barbecue may be partially raised utilizing handles 16 connected to the pan whereby ground contact is solely through those legs having wheels 14, the barbecue then being rollable to the position desired.

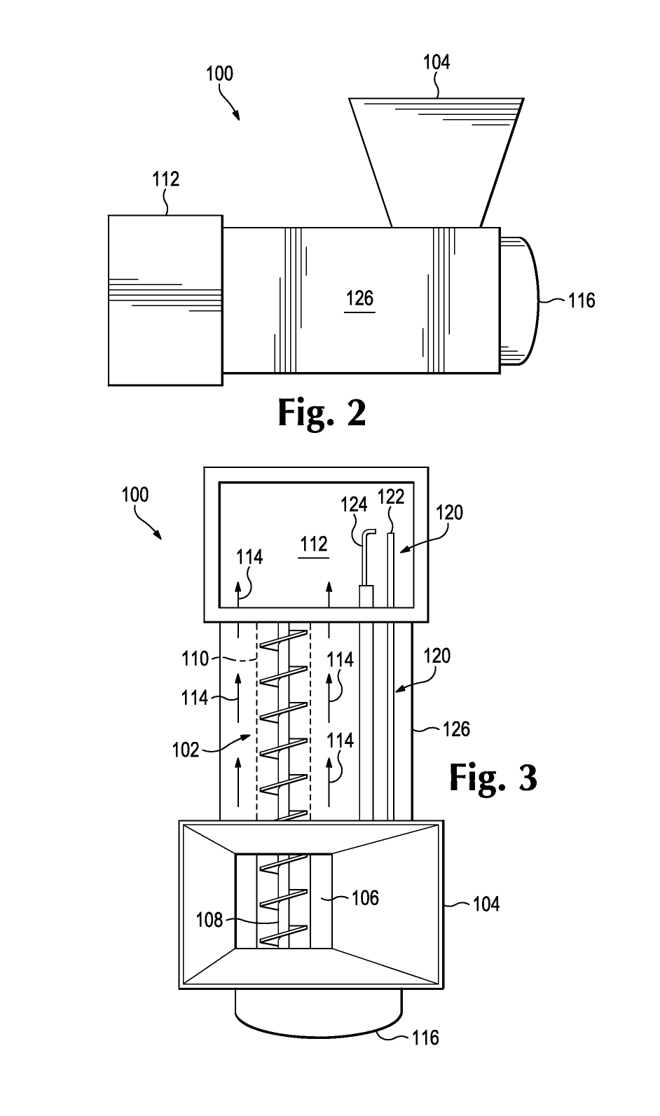

Pan 10 includes a bottom 20 and opposed side and end walls 22, 24 joined to bottom 20. The top of the pan may be reinforced as by framing 25. Pan 10 is open at the top. If desired, a hinged cover 26 may be included connected by hinges 28 to pan 10. The cover is swingable between a closed position where the cover closes off the top of the barbecue pan, as shown in FIG. 2, and an open position where the cover is swung to one side to expose the barbecue pan interior, as shown in FIG. 1. The cover may further include a ventilating hood as shown at 30.

A burner assembly 32 extends underneath the barbecue pan from approximately centrally of the pan to a position on one side thereof. In the specific embodiment of the invention disclosed, the burner assembly 33 includes an elongate housing 34 of substantially rectangular, i.e., square, cross section, and including top, bottom, and opposed side walls indicated at 36, 37, 38, and 39. The ends of the housing are closed off by end walls 41, 42.

Top wall 36 has a circular aperture 44 adjacent one end. Suitably secured as by welding within the housing and communicating with this aperture is a cylindrical fire pot 46 which is open at its top and closed at its bottom. The interior of the fire pot faces upwardly, and communicates with the interior of pan 10 through aperture 48 in bottom 20 of the pan. The cylindrical wall of the fire pot contains perforations 50.

With the construction described, the housing walls define a chamber extending along the interior of the housing and this chamber communicates through perforations 50 with the interior of the fire pot. Extending along the interior of housing 34 is a tube 52 having one end secured as by welding to the cylindrical wall of pot 46. The wall of the pot is cut out to provide an opening therein which communicates with the interior of tube 52. The opposite end of the tube is appropriately secured to end wall 42 of the housing.

Mounted within tube 52 is an elongate auger 54 terminating in a shaft 55. The shaft extends through wall 42 where it is supported in a bearing assembly 56. An electric gear motor 58 mounted on the end of the housing through bracket 60 has its output shaft connected through drive coupling 62 with the end of auger shaft 55.

Tube 52 is open at 64 and a wall 66 extending up from this opening provides a throat for the channelling of pellet fuel downwardly onto the auger to be fed thence by operation of the auger through the auger tube. A hopper 68 is supported on top of housing 34 which holds a supply of pellet fuel. The top wall of the housing is suitably cut away to place the base of the hopper in direct communication with the top of the throat defined by wall 66.

Supported on the underside of housing 34 approximately underneath the hopper is an electrically operated blower 70 having its discharge end connected through duct 74 with the chamber defined along the length of the interior of housing 34. A shutter 76 supported on the blower assembly by a pivot mounting 78 is adjustable to vary the degree of closure of intake 79 to the blower and, in this way, the amount of air flow produced by the blower through its discharge opening along the length of the housing.

The housing is supported on the underside of the pan through bolts 80 which extend upwardly from top wall 36 and through accommodating bores provided in the bottom of the pan, with securement completed using nuts screwed onto the protruding ends of the bolts. Gasket material 84 may be provided intermediate the top wall of the housing and the underside of the barbecue pan. Additional securement of the housing beneath the barbecue pan may be provided by securing a portion of the hopper to the side of the pan in an appropriate manner.

Disposed within the interior of the barbecue pan somewhat upwardly from the top of the fire pot is a nonperforate, metallic, baffle pan or plate shown at 90 including a floor and a raised shoulder extending about its perimeter. The baffle plate extends in a region disposed over the top of the fire pot and outwardly from this region to edges disposed inwardly somewhat from the side walls of the barbecue pan. The baffle plate is removably supported in this position as by legs 92 which may be joined either to the underside of the baffle pan or to the base of the barbecue pan with their opposite extremities unsecured. A food-support means or grill 96 is mounted within the interior of the barbecue pan and directly adjacent the top thereof, such grill being supported on support lugs 98 joined to the side walls of the barbecue pan.

To start up the barbecue, the grill is removed and the baffle pan tipped to an upright position which exposes the top of the fire pot. A small amount of wood pellets, i.e., a handful, are then placed in the fire pot together with combustible material such as paper, and the like. This is then lit, and combustion allowed to proceed for a short period of time such as two minutes or so. The baffle pan and grill may then be replaced in their operative positions, the air blower started, and the auger motor started. This produces forced-air circulation down the interior of housing 34 with the air blowing inwardly into the fire pot to support combustion of the material therein. The operation of the auger produces a gradual feed of replacement pellets to the fire pot, replacing material as such is burned. Normally a warmup period of only a few minutes is required after replacement of the grill and before cooking may proceed.

With the barbecue operating, food to be cooked may be placed on the grill. The blower produces forced-air circulation within the interior of the barbecue pan with heated air coming from the fire pot moving upwardly and around the baffle plate and thence circulating against and through the grill. Cooking may be performed with the cover in the closed position or with the cover open. With the cover closed, oven-like conditions are produced within the barbecue, and with the cover open, grill-like conditions are produced. The baffle plate on being heated radiates heat upwardly. Drippings from any food cooked are prevented from falling into the fire pot by the baffle plate which collects such material. With cooking concluded, the auger is stopped which stops feed of pellet material to the fire pot. With stoppage of pellet feed and with the blower turned off, combustion in the pot soon terminates.

FIGS. 2 and 3 illustrate a dual-fuel gas-pellet burner assembly 100 operable, for example, as a substitute for or alternative to burner assembly 32 described with reference to prior art pellet-burning barbecue 8 of FIG. 1.

Gas-pellet burner assembly 100 includes a pellet burner sub-assembly 102, generally analogous to pellet burner assembly 32 shown in FIG. 1, and a hopper 104 that receives and stores a supply of fuel (e.g., wood) pellets and feeds them through a pellet intake 106 to an auger 108 in a pellet shaft 110. Auger 108, being driven by an electrical motor (not shown), functions to feed the pellets along pellet shaft 110 and into a combustion chamber 112, which includes one or more perforations (not shown) to receive airflow 114 from a fan 116 to facilitate burning of the pellets. In addition to providing efficient combustion, but airflow 114 can also distribute heat resulting from the combustion in combustion chamber 112 throughout a barbecue to improve the cooking of food.

Gas-pellet burner assembly 100 further includes a gas burner sub-assembly 120 that includes a gas line or tube 122 receives a supply of cooking gas (e.g., propane, natural gas, etc., referred to generally as “gas”) to deliver the gas to combustion chamber 112. A gas igniter 124 is positioned in combustion chamber 112 to ignite gas delivered thereto. Pellet burner sub-assembly 102 and gas burner sub-assembly 120 are contained within a housing 126.

Gas burner sub-assembly 120 provides two functions in the operation of gas-pellet burner assembly 100. In one mode of operation, gas burner sub-assembly 120 functions as the initial pellet combustion igniter to begin combustion of the pellets of pellet burner sub-assembly 102. In this mode of operation, gas-pellet burner assembly 100 may be operated temporarily until pellets in combustion chamber 112 are ignited. In another mode of operation, gas burner sub-assembly 120 functions as a burner for cooking food operable independently of pellet burner sub-assembly 102. In this mode of operation, gas burner sub-assembly 120 may be operated alone or with concurrent operation of pellet burner sub-assembly 102. Likewise, after initial ignition, pellet burner sub-assembly 102 may be operated alone or with concurrent operation of gas burner sub-assembly 120. Combustion in combustion chamber 112, of either pellets or gas or both together, operates to cook food in a barbecue.

It will be appreciated, however, that differences between the combustion of pellets and gas allows dual-fuel gas-pellet burner assembly 100 to provide a wider range of operation than does conventional pellet burner assembly 32 (FIG. 1). The high energy content of cooking gas relative to wood fuel pellets can provide a significant increase in the heat that can be generated by gas-pellet burner assembly 100 relative to the heat that can be generated by conventional pellet burner assembly 32. The increased heat generation, whether gas is used alone or in combination with pellet fuel, allows gas-pellet burner assembly 100 to provide the heat necessary to operated larger barbecues at higher temperatures as may be required, for example, in commercial cooking applications.

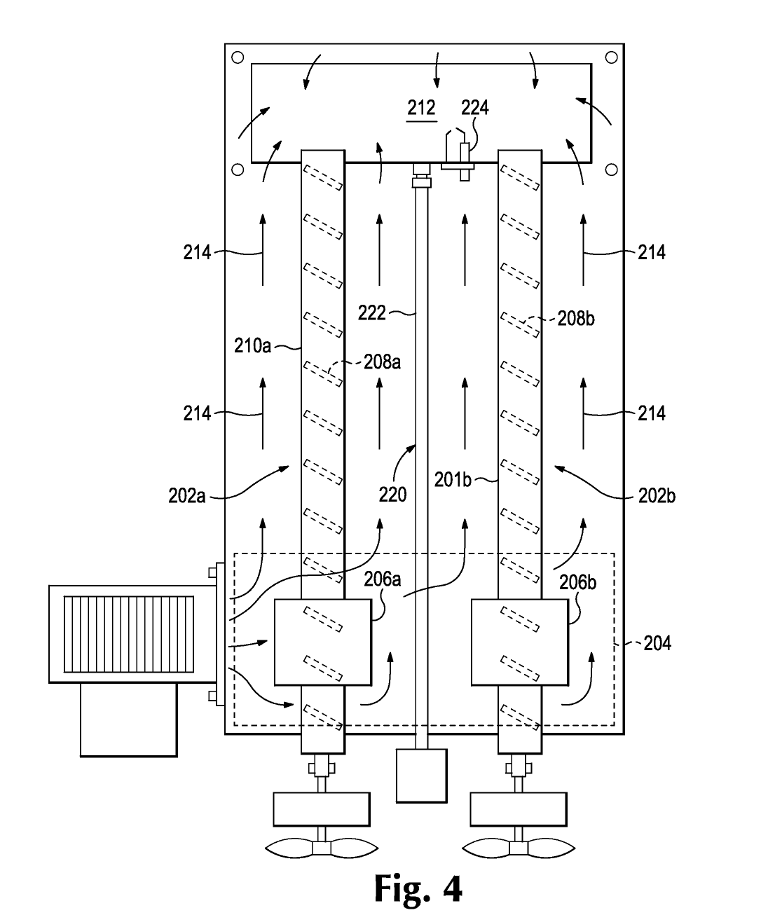

FIG. 4 is schematic plan view a dual-fuel gas-pellet burner assembly 200 operable also as a substitute for or alternative to burner assembly 32 of barbecue 8 (FIG. 1), for example, as another implementation of a dual-fuel gas-pellet burner according to the present invention. Gas-pellet burner assembly 200 includes first and second pellet burner sub-assemblies 202a and 202b, generally analogous to pellet burner sub-assembly 102 (FIG. 3). Pellet burner sub-assemblies 202a and 202b may include a shared hopper or separate hoppers (shown in outline as a shared hopper 204) that receives and stores a supply of fuel (e.g., wood) pellets and feeds them through pellet intakes 206a and 206b to augers 208a and 208b in pellet shafts 210a and 210b, respectively.

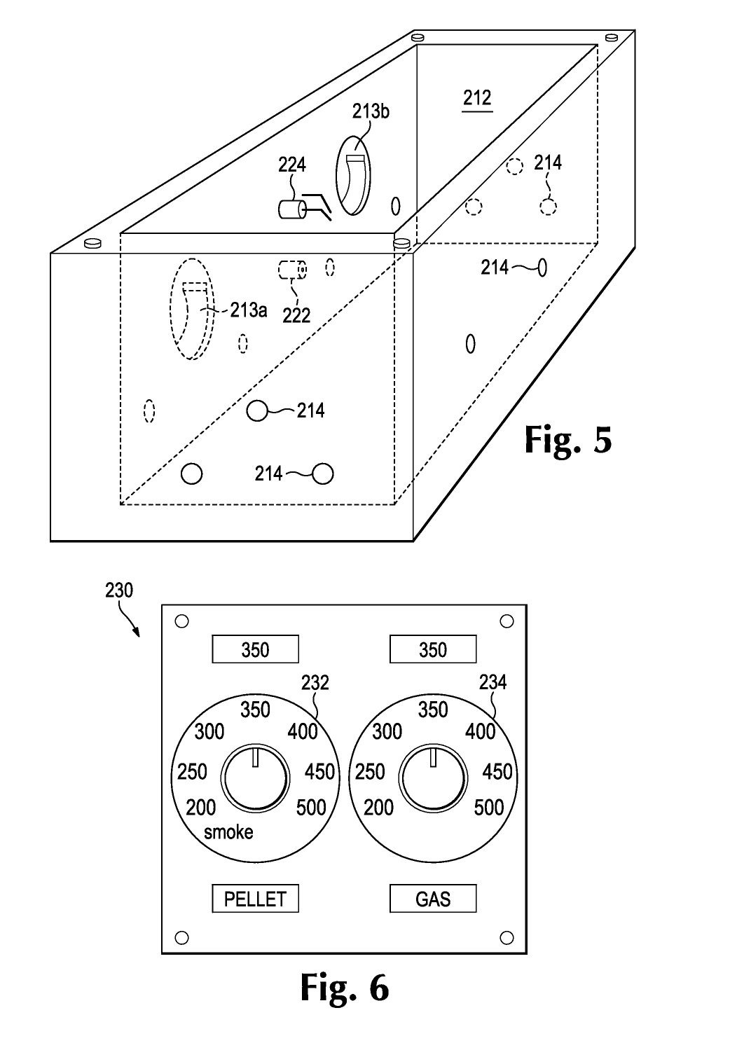

Referring also to FIG. 5, augers 208a and 208b are driven by electrical motors 211a and 211b and function to feed the pellets along respective pellet shafts 210a and 210b, through pellet shaft inlets 213a and 213b into a combustion chamber 212. Combustion chamber 212 may include multiple perforations 214 to improve airflow into and through combustion chamber 212 to facilitate burning of the pellets.

Gas-pellet burner assembly 200 further includes a gas burner sub-assembly 220 that includes a gas line or tube 222 receives a supply of cooking gas (e.g., propane, natural gas, etc., referred to generally as “gas”) to deliver the gas to combustion chamber 212. A gas igniter 224 is positioned in combustion chamber 212 to ignite gas delivered thereto and operates in substantially the manner described above with reference to igniter 124. With the high energy content of cooking gas relative to wood fuel pellets, first and second pellet burner sub-assemblies 202a and 202b of gas-pellet burner assembly 200 allow for a greater relative flow of pellets than in gas-pellet burner assembly 100, thereby to enrich the relative proportion of cooking from pellets to gas.

FIG. 6 is an illustration of a controller 230 that includes pellet burner control 232 and a separate gas burner control 234 for either of dual-fuel gas-pellet burners 100 and 200. As indicated, controller allows independent use and control of both the pellet burner sub-assembly and the gas burner sub-assembly of a dual-fuel gas-pellet burner.

One of skill in the art will recognize that the concepts taught herein can be tailored to a particular application in many other ways. In particular, those skilled in the art will recognize that the illustrated examples are but one of many alternative implementations that will become apparent upon reading this disclosure.

1. A dual-fuel gas-pellet barbecue burner assembly, comprising:
a combustion chamber;
a pellet burner assembly with a motor-driven auger to deliver fuel pellets to the combustion chamber;
a cooking gas line extending to the combustion chamber;
a cooking gas igniter in the combustion chamber;
and a user-operable cooking controller to control the pellet burner assembly and the cooking gas line.

2. The burner assembly of claim 1 in which the cooking controller includes a user-operable pellet burner controller and a user-operable cooking gas controller, the pellet burner controller and the cooking gas controller being user-operable separate from each other.

3. A dual-fuel gas-pellet barbecue burner assembly, comprising:
a combustion chamber;
a pellet burner sub-assembly with a motor-driven auger to deliver fuel pellets to the combustion chamber;
a gas burner sub-assembly having a gas igniter in and a gas line extending to the combustion chamber;
and a user-operable cooking controller to control the pellet and gas burner sub-assemblies.
